(19) United States
(12) Patent Application Publication
(10) Pub. No.: US 2025/0324377 A1
(43) Pub. Date: Oct. 16, 2025

(54) METHOD FOR DETECTING A USER EQUIPMENT IN A PREDETERMINED LOCATION AREA AROUND A MOTOR VEHICLE

(71) Applicant: Continental Automotive Technologies GmbH, Hannover (DE)

(72) Inventors: Rachid Benbouhout, Auterive (FR); Brahim Aloui, Toulouse (FR); Clément Ferry, Villeneuve Tolosane (FR)

(73) Assignee: Continental Automotive Technologies GmbH, Hannover (DE)

(21) Appl. No.: 19/056,075

(22) Filed: Feb. 18, 2025

(30) Foreign Application Priority Data
Apr. 11, 2024 (FR) FR2403758

(51) Int. Cl. H04W 60/00; H04B 17/318; H04W 4/40; H04W 4/80; H04W 12/06; H04W 12/63; H04W 24/08

(52) U.S. Cl. CPC H04W 60/00; H04B 17/328; H04W 4/40; H04W 4/80; H04W 12/06; H04W 12/63; H04W 24/08

(57) ABSTRACT

A method for detecting a user equipment in a predetermined location area around a motor vehicle including a plurality of communication modules configured to communicate with the user equipment over a wireless communication link. The peripheral limit of the predetermined location area being characterized by a predefined distance corresponding to a predefined signal power, called “reference power,” for a signal sent by the user equipment and received by one of the communication modules. The method notably including a step, during which, if the measured inter-module power is less than a predetermined inter-module power and if the measured inter-module phase shift is less than a predetermined inter-module phase shift, then confirming that the user equipment is in the predetermined location area around the vehicle.

### CROSS REFERENCE TO RELATED APPLICATIONS

This application claims priority to French Patent Application No. FR2403758, filed Apr. 11, 2024, the contents of such application being incorporated by reference herein.

### Field of the Invention

The present invention relates to the field of motor vehicles and more specifically relates to a method for detecting a user equipment in a predetermined location area around a motor vehicle.

### BACKGROUND OF THE INVENTION

In a motor vehicle, locating the user of the vehicle in a predetermined location area around the vehicle is known, for example less than two meters away, in order to activate functions such as, for example, unlocking the doors or adjusting the seat of the driver. To this end, several solutions exist that are based on different technologies.

Thus, in a first solution, for example, it is known for low-frequency (LF) location and radio-frequency communication to be used between the vehicle and a fob or a key of the user. However, this solution cannot be used with current smartphones, which are increasingly used to interact with the vehicle.

Another solution based on Bluetooth® technology, notably Bluetooth low energy (BLE) technology, and its location component, called “Channel Sounding” (BLE CS), is not precise enough because the bandwidth is limited to 80 MHz.

In order to at least partly overcome these disadvantages, a known solution based on Ultra-Wide Band (UWB) technology allows precise location using a 500 MHz wide frequency band. However, this solution is complex, expensive and energy-intensive.

Furthermore, known solutions do not solve the problem known as “body dumping”, which means that the location can significantly differ depending on whether the smartphone is carried in front of the user or in a back pocket or bag while the user is in the same place, since the reflected waves, from which the distance between the vehicle and the smartphone is computed, have very different strengths.

A simple, reliable and effective solution for at least partly overcoming these disadvantages therefore would be advantageous.

### SUMMARY OF THE INVENTION

To this end, the initial aim of the invention is a method for detecting a user equipment in a predetermined location area around a motor vehicle, said vehicle comprising a plurality of communication modules configured to communicate with said user equipment over a wireless communication link, the peripheral limit of said predetermined location area being characterized by a predefined distance corresponding to a predefined signal power, called “reference power”, for a signal sent by the user equipment and received by one of the communication modules, said method comprising the following steps of:
detecting and authenticating the user equipment;
exchanging signals between a first communication module and the user equipment and measuring the power, called “first power”, of said signals and exchanging signals between a second communication module and the user equipment and measuring the power, called “second power”, of said signals;
if the first power is less than the reference power and if the second power is less than the reference power, then exchanging signals between said first communication module and said second communication module, measuring the power, called “inter-module power”, of said signals and measuring the phase shift, called “inter-module phase”, between said signals;
if the measured inter-module power is less than a predetermined inter-module power and if the measured inter-module phase shift is less than a predetermined inter-module phase shift, then confirming that the user equipment is in the predetermined location area around the vehicle.

An aspect of the invention allows the user equipment to be located in the location area simply, reliably and efficiently. The method according to an aspect of the invention does not require energy-intensive and expensive equipment using UWB technology, for example. Finally, with the method according to an aspect of the invention and the use of a reference inter-module power and a reference inter-module phase shift, the user equipment is located in the location area irrespective of its position on the user (in the hand in free field conditions or in a pocket or a bag).

Preferably, the method further comprises a step of activating one or more functions of the vehicle such as, for example, unlocking the doors or adjusting the seat of the driver of the vehicle or welcome lighting in the vehicle, etc.

More preferably, the signals are exchanged between the first communication module, the second communication module and the user equipment over a propagation channel with a width of less than 200 MHZ, preferably less than 100 MHZ, more preferably of the order of 80 MHz.

More preferably, the signals are exchanged between the first communication module, the second communication module and the user equipment over a Bluetooth® Low Energy Channel Sounding type communication link.

In one embodiment, the user equipment is a smartphone configured to communicate over a Bluetooth® Low Energy Channel Sounding type wireless communication link.

In one embodiment, the user equipment is a key or a fob.

An aspect of the invention also relates to a computer program product characterized in that it comprises a set of program code instructions which, when they are executed by one or more processors, configure the one or more processors to implement a method as described above.

An aspect of the invention also relates to an electronic control unit for a motor vehicle for detecting a user equipment in a predetermined location area around said vehicle, the vehicle comprising a plurality of communication modules configured to communicate with said user equipment over a wireless communication link, the peripheral limit of said predetermined location area being characterized by a predefined distance corresponding to a predefined signal power, called “reference power”, for a signal sent by the user equipment and received by one of the communication modules, said electronic control unit being configured to:
detect and authenticate the user equipment;
control the exchange of signals between a first communication module of the vehicle and the user equipment and measure the power, called “first power”, of said signals;
control the exchange of signals between a second communication module of the vehicle and the user equipment and measure the power, called “second power”, of said signals;
if the first power is less than the reference power and if the second power is less than the reference power, control the exchange of signals between said first communication module and said second communication module, measure the power, called “inter-module power”, of said signals and measure the phase shift, called “inter-module phase”, between said signals;
if the measured inter-module power is less than a predetermined inter-module power and if the measured inter-module phase shift is less than a predetermined inter-module phase shift, confirm that the user equipment is in the predetermined location area around the vehicle.

An aspect of the invention also relates to a motor vehicle for detecting a user equipment in a predetermined location area around said vehicle, said vehicle comprising a plurality of communication modules configured to communicate with said user equipment over a wireless communication link, the peripheral limit of said predetermined location area being characterized by a predefined distance corresponding to a predefined signal power, called “reference power”, for a signal sent by the user equipment and received by one of the communication modules, said vehicle comprising an electronic control unit as described above.

An aspect of the invention also relates to a motor vehicle system comprising a vehicle as set forth above and a user equipment configured to communicate with the communication modules of the vehicle over a wireless communication link.

Preferably, the first communication module, the second communication module and the user equipment are each configured to exchange signals over a propagation channel with a width of less than 200 MHz, preferably less than 100 MHz, more preferably of the order of 80 MHz.

More preferably, the first communication module, the second communication module and the user equipment are each configured to exchange signals over a Bluetooth® Low Energy Channel Sounding type communication link.

In one embodiment, the user equipment is a smartphone configured to communicate over a Bluetooth® Low Energy Channel Sounding type wireless communication link.

### BRIEF DESCRIPTION OF THE DRAWINGS

Further features and advantages of aspects of the invention will become more clearly apparent upon reading the following description. This is purely illustrative and must be read with reference to the appended drawings, in which:

FIG. 1 schematically illustrates one embodiment of the system according to an aspect of the invention;

FIG. 2 schematically illustrates one embodiment of the method according to an aspect of the invention;

FIG. 3 is an example of power as a function of the frequency with and without nearby user equipment in the location area;

FIG. 4 is an example of phase shift as a function of frequency with and without nearby user equipment in the location area.

### DETAILED DESCRIPTION OF EXEMPLARY EMBODIMENTS

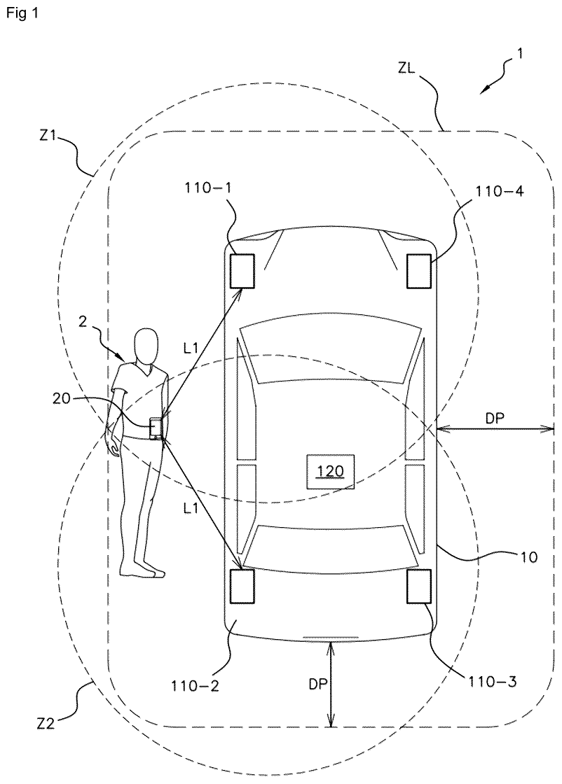

FIG. 1 schematically illustrates an example of a motor vehicle system 1 according to an aspect of the invention.

The system 1 comprises a motor vehicle 10 and a user equipment 20 carried by a user 2.

### Vehicle 1

In the example of FIG. 1, the vehicle 10 comprises four communication modules 110 and an electronic control unit 120. The front-left communication module is denoted 110-1, the rear-left communication module is denoted 110-2, the rear-right communication module is denoted 110-3 and the front-right communication module is denoted 110-4.

Each communication module 110 is configured to communicate with the user equipment 20 over a wireless communication link L1.

A predetermined location area ZL is defined around the vehicle 10. This location area ZL corresponds to the area where the user equipment 20 must be located in order to activate a predetermined function of the vehicle 10, such as, for example, unlocking the doors or activating welcome functions (lights, seat adjustments, etc.).

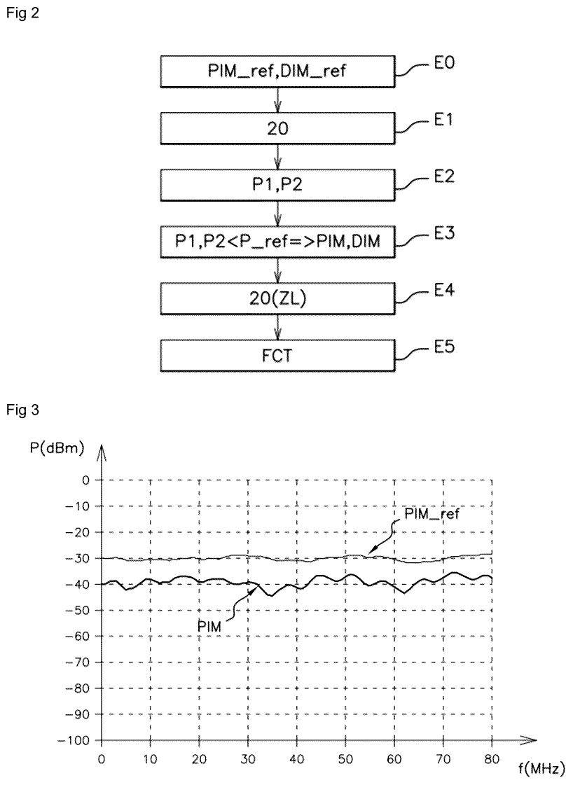

The peripheral limit of the predetermined location area ZL is characterized by a predefined distance DP corresponding to a predefined signal power, called reference power P_ref (FIG. 2), for a signal sent by the user equipment 20 and received by one of the communication modules 110.

### Electronic Control Unit 120

The electronic control unit 120 is configured to detect and authenticate the user equipment 20.

The electronic control unit 120 is configured to control the exchange of signals between a first communication module 110-1 of the vehicle 10 and the user equipment 20 and to measure the power of said signals, called “first power” P1 (FIGS. 2 to 4).

The electronic control unit 120 is configured to control the exchange of signals between a second communication module 110-2 of the vehicle 10 and the user equipment 20 and to measure the power of said signals, called “second power” P2 (FIGS. 2 to 4).

The electronic control unit 120 is configured, when the first power P1 is less than the reference power P_ref and when the second power P2 is less than the reference power P_ref, to control the exchange of signals between said first communication module 110-1 and said second communication module 110-2, to measure the power, called “inter-module power” PIM (FIGS. 2 to 4), of said signals and to measure the phase shift, called “inter-module phase” DIM (FIGS. 2 to 4), between said signals.

The electronic control unit 120 is configured, when the measured inter-module power PIM is less than a predetermined inter-module power, called “reference inter-module power PIM_ref” (FIGS. 2 to 4), and when the measured inter-module phase shift DIM is less than a predetermined inter-module phase shift, called “reference inter-module phase shift DIM_ref” (FIGS. 2 to 4), to confirm that the user equipment 20 is in the predetermined location area ZL around the vehicle 10.

The electronic control unit comprises a processor capable of implementing a set of instructions allowing these functions to be performed.

### User Equipment 20

The user equipment 20 is configured to communicate with the communication modules 110 of the vehicle 10 over a Bluetooth® Low Energy Channel Sounding type wireless communication link.

### Exemplary Implementation

As a prerequisite, it is understood that the reference power has been previously determined. This power corresponds to the signal power when a test user equipment 20 is placed at the limit of the location area ZL, for example exactly two meters away from the vehicle 10.

In a step E0, in the absence of a user equipment 20 around the vehicle 10 or in the vehicle 10, the electronic control unit 120 controls the exchange of signals between the first communication module 110-1 and the second communication module 110-2 and measures (or determines) both the power of said signals and the phase shift between said signals. The power measured in the absence of a user equipment 20 is called “reference inter-module power” and denoted PIM_ref and the phase shift measured in the absence of a user equipment 20 is called “reference inter-module phase shift” and denoted DIM_ref.

Firstly, in a step E1, the electronic control unit 120 detects and authenticates the user equipment 20. Detection is carried out by controlling the periodic transmission of beacon signals via the communication modules 110 over a BLE communication link, with said beacon signals being able to be conveyed up to several tens of meters, and by receiving a response from the user equipment 20, yet without locating said user equipment. Once detected, messages are exchanged between the electronic control unit 120, still over a BLE communication link, via at least one of the communication modules 110, in order to authenticate the user equipment 20. Detection and authentication are preferably carried out by the communication modules 110 toward which the user equipment 20 approaches. Detection and authentication can be carried out remotely when the user equipment 20 is still outside the predetermined location area ZL.

In this example, with reference to FIG. 1, the user 20 is heading toward the driver door located between the front-left communication module, called “first module 110-1” and the rear-left communication module, called “second module 110-2”.

In a step E2, the electronic control unit 120 controls the exchange of signals between the first communication module 110-1 and the user equipment 20 and measures the power, called “first power” P1, of said signals and the exchange of signals between the second communication module 110-2 and the user equipment 20 and measures the power, called “second power” P2, of said signals.

When the first power P1 is less than the reference power P_ref and when the second power P2 is less than the reference power P_ref, reflecting the probable presence of the user equipment 20 in each of the coverage areas Z1, Z2 (FIG. 1) of the first communication module 110-1 and of the second communication module 110-2, i.e., in the location area ZL, the electronic control unit 120 controls the exchange of signals between the first communication module 110-1 and the second communication module 110-2 and measures (or determines) both the power, called “inter-module power” PIM, of said signals and the phase shift, called “inter-module phase shift” DIM, between said signals in a step E3.

When the measured inter-module power PIM is less than the predetermined reference inter-module power PIM_ref and when the measured inter-module phase shift DIM is less than the predetermined reference inter-module phase shift DIM_ref, then the electronic control unit 120 confirms that the user equipment 20 is in the predetermined location area ZL around the vehicle 10 in a step E4, and then activates one or more functions FCT of the vehicle 10, such as, for example, unlocking the doors, in a step E5.

### Examples of Measurements

FIG. 3 shows an example of measured power P (in dBm) as a function of the frequency f (in MHz) over the width of the propagation channel, namely 80 MHz. The average reference inter-module power PIM_ref, measured beforehand over the width of the propagation channel in the absence of user equipment 20 around the vehicle 10, is of the order of −30 dBm. In the presence of a user equipment 20, the inter-module power PIM measured over the width of the propagation channel is of the order of −40 dBm. This −10 dBm drop reflects the presence of a user equipment 20.

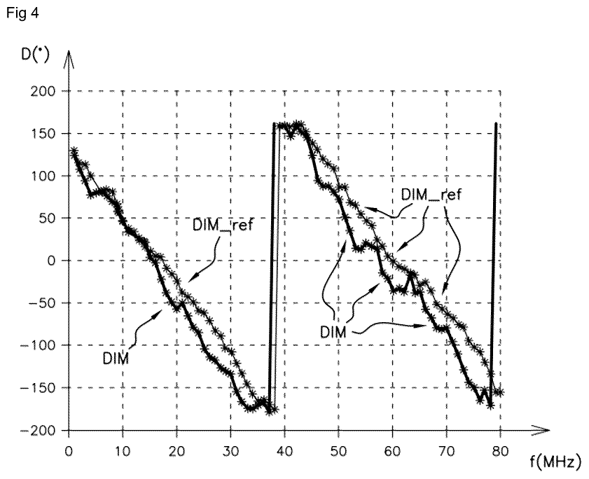

FIG. 4 shows an example of measured phase shift D (in degrees) as a function of the frequency f (in MHZ) over the width of the propagation channel, namely 80 MHz. It can be seen that the inter-module phase shift DIM measured in the presence of a user equipment 20 decreases, both before and after the phase inversion that occurs around 38 MHZ, being lower on average than the reference inter-module phase shift DIM_ref, measured beforehand over the width of the propagation channel in the absence of a user equipment 20 around the vehicle 10.

An aspect of the invention therefore allows the detection (power) and confirmation (phase shift) of the presence of a user equipment 20 in the location area ZL in a simple, fast, effective and reliable manner in order to activate one or more functions of the vehicle 10, notably such as unlocking or welcome functions.

1. A method for detecting a user equipment in a predetermined location area around a motor vehicle, said vehicle comprising a plurality of communication modules configured to communicate with said user equipment over a wireless communication link, the peripheral limit of said predetermined location area being characterized by a predefined distance corresponding to a predefined signal power, called “reference power”, for a signal sent by the user equipment and received by one of the communication modules, said method comprising:
detecting and authenticating the user equipment;
exchanging signals between a first communication module and the user equipment and measuring the power, called “first power”, of said signals and exchanging signals between a second communication module and the user equipment and measuring the power, called “second power”, of said signals;
if the first power is less than the reference power and if the second power is less than the reference power,exchanging signals between said first communication module and said second communication module, measuring the power, called “inter-module power”, of said signals and measuring the phase shift, called “inter-module phase”, between said signals;
if the measured inter-module power is less than a predetermined inter-module power and if the measured inter-module phase shift is less than a predetermined inter-module phase shift, then confirming that the user equipment is in the predetermined location area around the vehicle.

2. The method as claimed in claim 1, wherein the signals are exchanged between the first communication module, the second communication module and the user equipment over a propagation channel with a width of less than 200 MHz, preferably less than 100 MHZ, more preferably of the order of 80 MHz.

3. The method as claimed in claim 2, wherein the signals are exchanged between the first communication module, the second communication module and the user equipment over a Bluetooth® Low Energy Channel Sounding type communication link.

4. The method as claimed in claim 1, wherein the user equipment is a smartphone configured to communicate over a Bluetooth® Low Energy Channel Sounding type wireless communication link.

5. A non-transitory computer program product, comprising a set of program code instructions which, when they are executed by one or more processors, configure the one or more processors to implement a method as claimed in claim 1.

6. An electronic control unit for a motor vehicle for detecting a user equipment in a predetermined location area around said vehicle, the vehicle comprising a plurality of communication modules configured to communicate with said user equipment over a wireless communication link, the peripheral limit of said predetermined location area being characterized by a predefined distance corresponding to a predefined signal power, called “reference power”, for a signal sent by the user equipment and received by one of the communication modules, said electronic control unit being configured to:
detect and authenticate the user equipment;
control the exchange of signals between a first communication module of the vehicle and the user equipment and measure the power, called “first power”, of said signals;
control the exchange of signals between a second communication module of the vehicle and the user equipment and measure the power, called “second power”, of said signals;
if the first power is less than the reference power and if the second power is less than the reference power, control the exchange of signals between said first communication module and said second communication module, measure the power, called “inter-module power”, of said signals and measure the phase shift, called “inter-module phase”, between said signals;
if the measured inter-module power is less than a predetermined inter-module power and if the measured inter-module phase shift is less than a predetermined inter-module phase shift, confirm that the user equipment is in the predetermined location area around the vehicle.

7. A motor vehicle for detecting a user equipment in a predetermined location area around said vehicle, said vehicle comprising a plurality of communication modules configured to communicate with said user equipment over a wireless communication link, the peripheral limit of said predetermined location area being characterized by a predefined distance corresponding to a predefined signal power, called “reference power”, for a signal sent by the user equipment and received by one of the communication modules, said vehicle comprising an electronic control unit as claimed in claim 6.

8. A motor vehicle system comprising a vehicle as claimed in claim 7 and a user equipment configured to communicate with the communication modules of the vehicle over a wireless communication link.

9. The system as claimed in claim 8, wherein the first communication module, the second communication module and the user equipment are each configured to exchange signals over a propagation channel with a width of less than 200 MHz, preferably less than 100 MHZ, more preferably of the order of 80 MHz.

10. The system as claimed in claim 8, wherein the first communication module, the second communication module, and the user equipment are each configured to exchange signals over a Bluetooth® Low Energy Channel Sounding type communication link.

11. The system as claimed in claim 9, wherein the first communication module, the second communication module, and the user equipment are each configured to exchange signals over a Bluetooth® Low Energy Channel Sounding type communication link.
